(19) United States
(12) Patent Application Publication
(10) Pub. No.: US 2008/0008122 A1
(43) Pub. Date: Jan. 10, 2008

(54) Apparatus and method for concurrently supporting data service and voice service

(75) Inventor: Seung-Il Yoon, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/822,038

(22) Filed: Jul. 2, 2007

(30) Foreign Application Priority Data
Jul. 4, 2006 (KR) 10-2006-0062640

(51) Int. Cl. H04Q 7/00

(52) U.S. Cl. 370/328

(57) ABSTRACT

A system and method are provided for concurrently supporting a data service and circuit based voice service in the data mode when a mobile communication system is operating in the data mode, including steps for, when a Base Station (BS) pages a Mobile Station (MS) in the data mode, forming a message to provide the circuit based voice service in the data mode by the BS and transmitting the message to the MS, forming a message as response to provide the circuit based voice service in the data mode by the MS and transmitting the message to the BS; establishing a traffic channel and a Quality of Service (QoS) setup to provide the circuit based voice in the data mode service by using the information included in the messages.

### CROSS-REFERENCE TO RELATED APPLICATIONS

This application claims the benefit under 35 U.S.C. §119(a) of Korean Patent Application No. 10-2006-0062640 filed in the Korean Intellectual Property Office on Jul. 4, 2006, the entire disclosure of which is incorporated herein by reference.

### BACKGROUND OF THE INVENTION

1. Field of the Invention

The present invention relates to a mobile communication system. More particularly, the present invention relates to a technique for interworking a Mobil Switching Center (MSC) and a Code Division Multiple Access (CDMA) 2000 1× Evolution-Data Optimized (EV-DO) Access Network (AN)/Packet Control Function (PCF) so that CDMA 2000 1× voice call incoming is supported while maintaining the connection of a CDMA 2000 1× EV-DO packet session to a Mobile Station (MS).

2. Description of the Related Art

FIG. 1 illustrates a process of transmitting Code Division Multiple Access (CDMA) 2000 1× paging when a CDMA 2000 1× Evolution-Data Optimized (EV-DO) session is connected according to the prior art.

When CDMA 2000 1× paging is requested in a state where a CDMA 2000 1×EV-DO packet session is connected, a Mobile Switching Center (MSC) 140 sends a paging request to a Mobile Station/Access Terminal (MS/AT) 110 via a High Rate Packet Data Access Network/Packet Control Function (AN/PCF) 120 and a 1× Base Station (BS) 130 in steps 150 and 155. The HRPD AN/PCF 120 is also referred to as a CDMA 2000 1× EV-DO AN/PCF. The MS/AT 110 is a mobile terminal.

The HRPD AN/PCF 120 supports a CDMA 2000 1× paging request process, and thus, the MS/AT 110 can receive a paging request message from either the 1× BS 130 or the HRPD AN/PCF 120 in step 160.

Upon receiving the paging request, the MS/AT 110 transmits a paging response message to the 1× BS 130 and thus provides a CDMA 2000 1× voice incoming service.

At this time, the MS/AT 110 stops backward data packet transmission. Thus, the HRPD AN/PCF 120 changes the CDMA 2000 1× EV-DO packet session from a connection state to a dormant state.

Even when the MS/AT 110 and a Packet Data Service Node (PDSN) are temporarily in the dormant state after the CDMA 2000 1× EV-DO packet session is established, a packet may need to be continuously delivered.

Therefore, when the MS/AT 110 supports a concurrent service defined in the CDMA 2000 1× standard in which voice and packet services can be concurrently provided, the CDMA 2000 1× EV-DO packet session is converted to a CDMA 2000 1× packet session.

In this case, the PDSN used in the CDMA 2000 1× EV-DO packet session can also be used in the CDMA 2000 1× packet session.

Before a CDMA 2000 1× voice incoming request is generated, if the CDMA 2000 1× EV-DO packet is in the dormant state and if a packet is not generated by the MS/AT 110 or the PDSN during the provision of a packet service, a CDMA 2000 1× voice service is performed without alteration through the 1× BS 130.

An interface among the MSC, the CDMA 2000 1× BS, and the CDMA 2000 1× EV-DO is defined in the Inter-Operability Specification (ISO) version 5.0. According to the ISO version 5.0, the CDMA 2000 1× voice service is provided using a Real-time Transport Protocol (RTP) between an MSC Emulation (MSCe) and the 1× BS 130 or between the MSCe and the HRPD AN/PCF 120 through A1p and A2p interfaces.

The voice service may be provided between the MS/AT 110 and the 1× BS 130 by using data in the format of Enhanced Voice Rated Codec (EVRC), as conventionally used. The voice service may be provided between the 1× BS 130 and the MSCe by transmitting voice data (e.g., the EVRC) included in an RTP payload.

Generally, when voice incoming is required in the CDMA 2000 1× voice service, the CDMA 2000 1× EV-DO packet session is temporarily stopped, that is, the CDMA 2000 1× EV-DO packet session changes to the dormant state.

In a case where a packet service has to be continuously provided and where the MS/AT 110 and the 1× BS 130 provide a concurrent service (i.e., both a voice service and a packet service), the packet service can be continuously provided using the CDMA 2000 1× packet service through the 1× BS 130.

However, even in this case, there is a limit in a possible coverage range of the CDMA 2000 1× packet service. Therefore, the use of a high speed data service supported by the CDMA 2000 1× EV-DO experiences obstacles and delays when the packet service is provided.

In particular, in some cases, service quality significantly deteriorates, for example, when an application program demands a data transfer rate higher than a maximum data transfer rate provided in the CDMA 2000 1× packet service, or when a streaming service is received while continuous packet transmission is required on the real-time basis even though a required packet bandwidth is not high.

Accordingly, a need exists for a system and method wherein data service and voice service are concurrently supported when a mobile communication system is operating in a data mode.

### SUMMARY OF THE INVENTION

Exemplary embodiments of the present invention are provided to substantially solve the above and other problems, and provide an apparatus and method for concurrently supporting a data service and a voice service when a mobile communication system is operating in a data mode.

Exemplary embodiments of the present invention also provide an apparatus and method for concurrently supporting a Code Division Multiple Access (CDMA) 2000 1× voice service together with a high speed data service through a CDMA 1× Evolution-Data Optimized (EV-DO) packet session.

Exemplary embodiments of the present invention also provide an apparatus and method capable of providing a CDMA 2000 1× voice service to a Mobile Station (MS) through a CDMA 2000 1× EV-DO Access Network (AN)/Packet Control Function (PCF).

Exemplary embodiments of the present invention also provide an apparatus and method for facilitating changes to Voice over IP (VoIP) by effectively interworking wireless networks (e.g., a CDMA 2000 1× EV-DO network) based on a packet service with respect to a core network for providing an existing voice service.

Exemplary embodiments of the present invention also provide an apparatus and method for transmitting/receiving voice data (e.g., Enhanced Voice Rated Codec (EVRC)) included in a Real-time Transport Protocol (RTP) payload between an MS and a CDMA 2000 1×EV-DO AN/PCF.

According to one aspect of exemplary embodiments of the present invention, a method is provided for concurrently supporting a data service operating in a data mode and a voice service operating in a circuit mode when a mobile communication system is operating in the data mode, comprising the steps of, when a Base Station (BS) pages a Mobile Station (MS) in the data mode, forming a message including information required by the BS to provide the voice service while in the data mode and transmitting the message to the MS, forming a message including information required by the MS to provide the voice service while in the data mode and transmitting the message to the BS and after the BS and the MS exchange the messages, establishing a traffic channel and a Quality of Service (QoS) which are required to provide the voice service by using the information included in the messages.

According to another aspect of exemplary embodiments of the present invention, a BS apparatus is provided for concurrently supporting a data service operating in a data mode and a voice service operating in a circuit mode when a mobile communication system is operating in the data mode, comprising a data packet processor which receives a data packet from an upper layer network device or an MS and respectively transmits it to the MS or the upper layer network device through an interface module and which manages data consistency when the data is included in the data packet and is used to control delivery of the data packet. The apparatus further comprises a message processor which controls a flow of the data packet, generates a message to be transmitted to the MS wherein the message includes information required to provide the voice service while in the data mode, and which analyzes a response message transmitted from the MS so as to obtain the information. The apparatus still further comprises a controller which controls the data packet processor and the message processor and supports both the data service and the voice service while in the data mode, and which, if a session has to be reestablished in the data mode, determines a voice service handoff to a BS whose coverage overlaps that of the apparatus.

According to another aspect of exemplary embodiments of the present invention, an MS apparatus is provided for concurrently supporting a data service operating in a data mode and a voice service operating in a circuit mode when a mobile communication system is operating in the data mode, comprising a data packet processor which receives a data packet from a BS and thus obtains voice data from the data packet and which allows the voice data to be included in the data packet, a message processor which controls a flow of the data packet, uses a message transmitted from the BS to obtain information required to provide the voice while in the data mode, and generates a response message including the information, and a controller which controls the data packet processor and the message processor.

According to another aspect of exemplary embodiments of the present invention, a mobile communication system is provided for concurrently supporting a data service operating in a data mode and a voice service operating in a circuit mode while the mobile communication system is operating in the data mode, comprising a BS which, while a data service is provided to an MS, transmits a paging request message and a message including information required to provide the voice service and which provides the voice service when a response message is received, and the MS which receives the paging request message and the message including information required to provide the voice service while the data service is provided, provides the information by transmitting the response message, receives the circuit-mode voice data included in the data packet and then provides the circuit-mode voice service while the data service is provided.

### BRIEF DESCRIPTION OF THE DRAWINGS

The above and other objects, features and advantages of exemplary embodiments of the present invention will become more apparent from the following detailed description when taken in conjunction with the accompanying drawings, in which:

FIG. 1 illustrates a process of transmitting Code Division Multiple Access (CDMA) 2000 1× paging when a CDMA 2000 1× Evolution-Data Optimized (EV-DO) session is connected according to the prior art;

FIG. 2 illustrates a process of establishing a CDMA 2000 1× voice service over Real-time Transfer Protocol (RTP) in a state where a CDMA 2000 1× EV-DO session is activated according to an exemplary embodiment of the present invention;

FIG. 3 is a view for illustrating a process of handling RTP transmission traffic including a CDMA 2000 1× voice frame between a Mobile Switching Center Emulation (MSCe) and a Mobile Station (MS) according to an exemplary embodiment of the present invention;

FIG. 4 is a view for illustrating a process of handling RTP transmission traffic including a CDMA 2000 1× voice frame between a Mobile Switching Center (MSC) and an MS according to an exemplary embodiment of the present invention;

FIG. 5 illustrates a process of a CDMA 2000 1× voice handoff from a CDMA 2000 1× EV-DO Access Network (AN)/Packet Control Function (PCF) to a CDMA 2000 1× Base Station (BS) according to an exemplary embodiment of the present invention;

FIGS. 6A and 6B illustrate a format of a message “A2p Bearer Session Level Parameter” and a format of a message “A2p Format-specific parameter” according to an exemplary embodiment of the present invention;

FIG. 7 is a block diagram of a BS that supports a CDMA 2000 1× voice service based on RTP in a state where a CDMA 2000 1× EV-DO session is activated according to an exemplary embodiment of the present invention; and

FIG. 8 is a block diagram of an MS that supports a CDMA 2000 1× voice service based on RTP in a state where a CDMA 2000 1× EV-DO session is activated according to an exemplary embodiment of the present invention.

### DETAILED DESCRIPTION OF THE EXEMPLARY EMBODIMENTS

Exemplary embodiments of the present invention will now be described herein below with reference to the accompanying drawings. In the following description, well-known functions or constructions are not described in detail since they would obscure the invention in unnecessary detail.

Upon receiving a paging request message for a Code Division Multiple Access (CDMA) 2000 1× voice service, a CDMA 2000 1× Evolution-Data Optimized (EV-DO) Access Network (AN)/Packet Control Function (PCF) provides notification of the reception of the paging request message to a Mobile Station (MS) using a Circuit Service Notification Application (CSNA) which indicates that a circuit service will be provided.

In this case, if a caller's phone number is received together with the paging request message, a Feature Notification (FN) message is transmitted to the MS together with a General Page Message (GPM).

The FN message includes the caller's phone number. The GPM is used to call the MS.

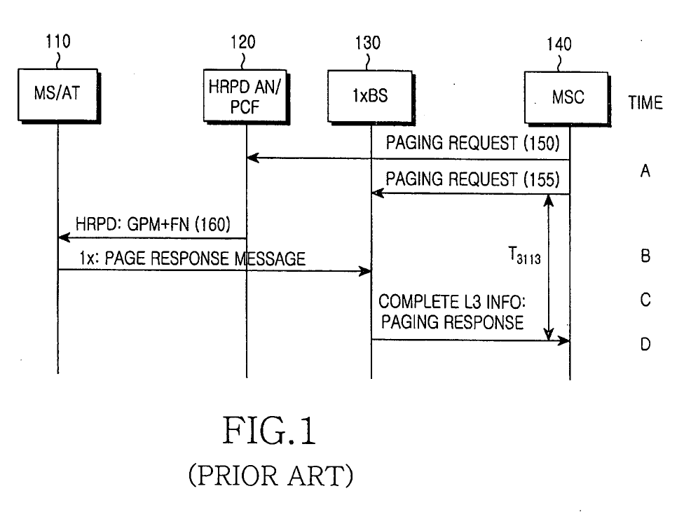

In a manner similar to FIG. 1, when an MS receives a message “GPM+FN” from a CDMA2000 1× EV-DO AN/PCF, upon receiving a CDMA 2000 1×voice paging request, a CDMA2000 1× EV-DO packet session changes to a dormant state, and at the same time, a Page Response Message (PRM) is transmitted to a CDMA 2000 1× Base Station (BS).

Thus, in order to support a CDMA 2000 1× voice service while continuously using a high data service through the CDMA 1× EV-DO packet session, there is a need for a technique for transmitting the PRM to the CDMA 1× EV-DO AN/PCF so that the CDMA 1× EV-DO packet session can be continuously used.

Exemplary embodiments of the present invention provide a system and method for interworking a Mobil Switching Center (MSC) and a Code Division Multiple Access (CDMA) 2000 1× Evolution-Data Optimized (EV-DO) Access Network (AN)/Packet Control Function (PCF) (herein, AN and PCF may be included in a Base Station (BS)), so that CDMA 2000 1× voice call incoming is supported while maintaining the connection of a CDMA 2000 1× EV-DO packet session to a Mobile Station (MS). Further, embodiments of the present invention provide a system and method for providing a CDMA 2000 1× voice service in such a manner that an MS and a CDMA 2000 1× EV-DO AN/PCF are connected using Voice Over Internet Protocol (VoIP) or Real Time Protocol (RTP), and the CDMA 2000 1× EV-DO AN/PCF and an MSC are connected using Integrating Wireless Services Function (IWSF, so that CDMA 2000 1× voice call incoming is supported while maintaining the connection of a CDMA 2000 1× EV-DO packet session to the MS.

To do so, exemplary embodiments of the present invention provide an apparatus and method for concurrently supporting a CDMA 2000 1× voice service together with a high speed data service through a CDMA 1× EV-DO packet session.

Hereinafter, an exemplary apparatus and method for concurrently providing a data service operating in a data mode and a voice service operating in a circuit mode will be described when a mobile communication system is operating in the data mode.

First, a process of establishing and providing a CDMA 2000 1× voice service paging request reception service (or an incoming voice call service) will be described.

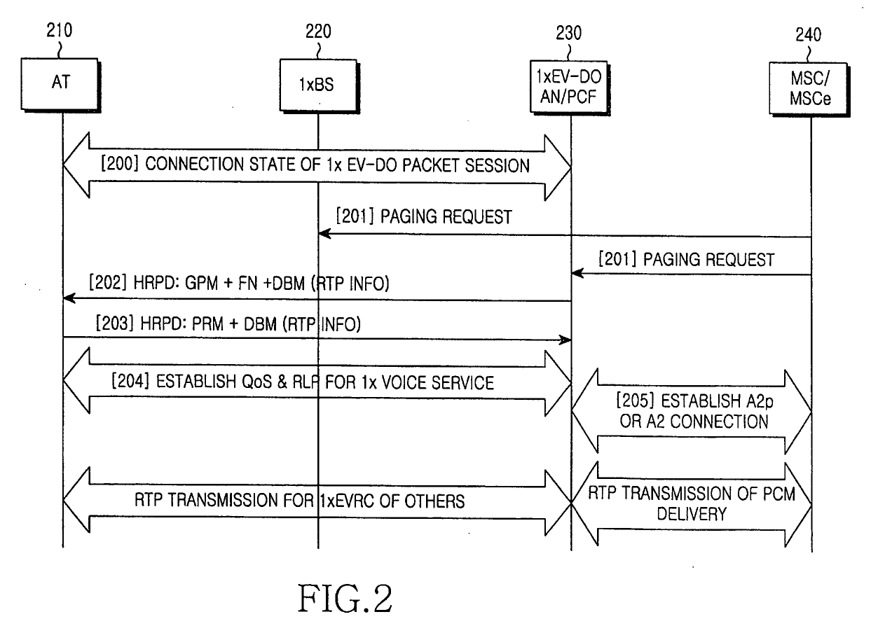

FIG. 2 illustrates a process of establishing a CDMA 2000 1× voice service over Real Time Protocol (RTP) in a state where a CDMA 2000 1× EV-DO session is activated according to an embodiment of the present invention.

Referring to FIG. 2, in step 200, an Access Terminal (AT) 210 is in a state where a 1× EV-DO packet session is connected (activation state).

In steps 201, a 1× EV-DO AN/PCF 230 receives a CDMA 2000 1× paging request from a Mobile Switching Center (MSC)/MSC Emulation (MSCe) 240. In this case, the paging request is also transmitted to a 1× Base Station (BS) 220.

In step 202, the 1× EV-DO AN/PCF 230 transmits a message “GPM+FN” (herein, FN is optional) to the AT 210.

According to exemplary embodiments of the present invention, a Data Burst Message (DBM) is also transmitted in step 202. The DBM is used to request a CDMA 2000 1× voice service using RTP between the 1× EV-DO AN/PCF 230 and the AT 210.

When the AT 210 establishes the CDMA 2000 1× voice service using a conventional scheme or when a Not Known (NK) state is set even after the DBM is received, the AT 210 may transmit the PRM to the 1× BS 220.

According to exemplary embodiments of the present invention, if the AT 210 supports a 1× voice incoming service by transmitting RTP information to the 1× EV-DO AN/PCF 230, a DBM having the same format as that received in step 202 is transmitted together with the PRM in step 203.

When the CDMA 2000 1× voice service is provided in the CDMA 2000 1× EV-DO packet session, a traffic channel between the AT 210 and the 1× EV-DO AN/PCF 230 can be used without alteration.

A voice service has features in that, for example, a certain amount of packet loss is permitted, small-sized data can be transmitted on the real time basis, and out-of-order delivery is permitted to some extent. According to these features, in a case where a Multi-Flow Packet Application (MFPA) or an Enhanced MFPA can be used to permit a multiple data flow supported by the CDMA 2000 1× EV-DO Rev.A, a separate Radio Link Protocol (RLP) may be established between the AT 210 and the 1× EV-DO AN/PCF 230. The RLP transmission is performed to carry voice data.

If possible, a RObust Header Compression (ROHC) technique may be employed when transmitting/receiving the RTP information between the AT 210 and the 1× EV-DO AN/PCF 230. In this case, by compressing headers, an overall throughput increases, and transmission delay is reduced.

In step 204, when the RLP is established between the 1× EV-DO AN/PCF 230 and the AT 210, a Quality of Service (QoS) wireless section is also established in consideration of the characteristics of the RTP transmission.

In step 205, the 1× EV-DO AN/PCF 230, which has received the DBM and the CDMA 2000 1× PRM transmitted from the AT 210 in step 203, establishes a traffic channel with respect to the MSC/MSCe 240 for processing CDMA 2000 1× voice data, using the RTP information included in the DBM. Traffic channels for RTP transmission for 1× EVRC of others, and RTP transmission of PCM delivery can then be provided.

In the DBM exchanged between the AT 210 and the 1× EV-DO AN/PCF 230, a new burst type is defined using the existing DBM.

The new burst type and parameters included in the DBM are listed by way of example in Table 1 below.

TABLE 1

| | | |
|---|---|---|
| Burst | | Associated |
| Type (Binary) | Designed Use // Type of Service | Standards |

| | |
|---|---|
| 000000~000111 | // Already Defined |
| 001010 | 1x Voice over RTP in 1x EV-DO |
| 111110~11111 | // Already Defined |
| | -Burst Type 001010 Format |
| Max Frames | When CDMA 2000 1x voice data is consistently |
| IP Address | transmitted using RTP between CDMA 2000 |
| UDP Port | 1x AN/PCF and MSCe (i.e., A1p and A2p |
| RTP Payload | interfaces are used), information shown in the |
| Type | left side is maintained to coincide with |
| | information included in “A2p Bearer Session |
| | Level Parameter” and information included |
| | in “A2p Format-specific parameter”. |

Herein, “IP Address” represents an IP address of a corresponding device, “User Datagram Protocol (UDP) port” represents an address of a UDP port to be used, and “RTP Payload Type” represents a payload type of an RTP packet. Further, “Max Frames” represents the number of 20 ms voice frames included in one RTP packet.

When the CDMA 2000 1× voice data is transmitted between the CDMA 2000 1× AN/PCF and the MSCe by using RTP (i.e., in the case of using the Alp and A2p interfaces), the above described information has to be maintained to coincide with information contained in a message “A2p Bearer Session Level Parameter” exchanged between the CDMA 2000 1× AN/PCF and the MSCe and information contained in a message “A2p Format-specific parameter”.

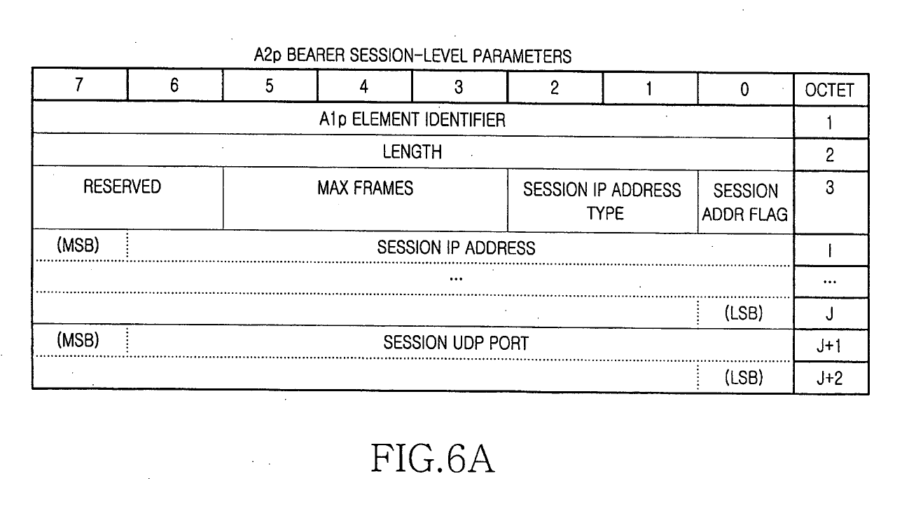

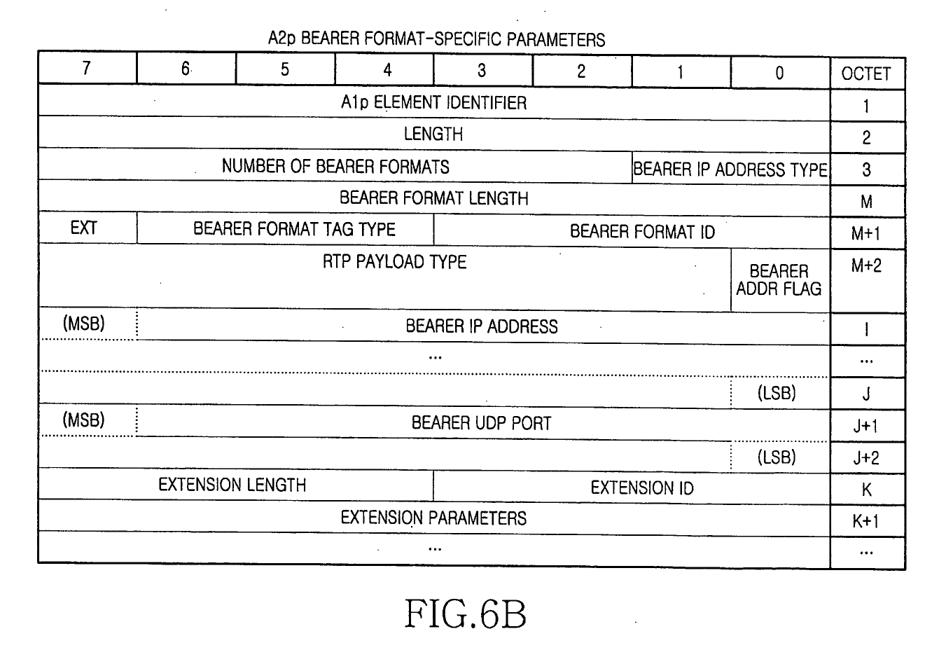

An exemplary format of the message “A2p Bearer Session Level Parameter” is shown in FIG. 6A, and an exemplary format of the message “A2p Format-specific parameter” is shown in FIG. 6B.

Now, a technique for processing CDMA 2000 1× voice data over RTP in a CDMA 2000 1× EV-DO AN/PCF in accordance with an exemplary embodiment of the present invention will be described.

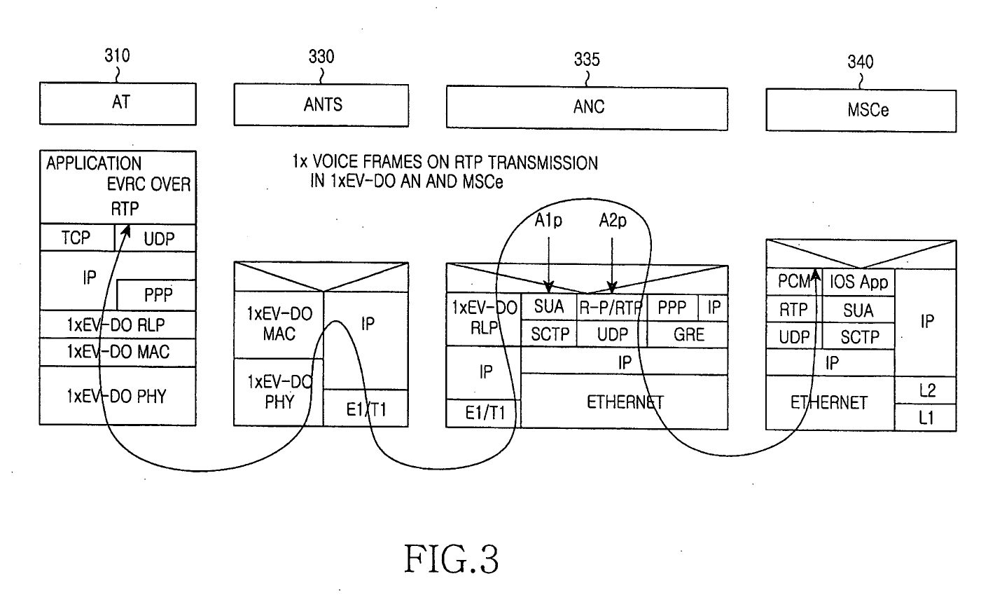

FIG. 3 is a view for illustrating a process of handling RTP transmission traffic including a CDMA 2000 1× voice frame between an MSCe and an MS according to an exemplary embodiment of the present invention.

Referring to FIG. 3, the RTP transmission traffic including the CDMA 2000 1× voice frame between the MSCe 340 and the AT 310 is shown by using a protocol stack.

A curve indicated by a solid line arrow represents an exemplary path along which an RTP packet is transmitted through the A2p interface. Signaling information is transmitted through the Alp interface.

In the case of using the MSCe 340, an Access Network Transceiver Station (ANTS) 330 and an Access Network Controller (ANC) 335 directly transmit the RTP packet transmitted to and received from the AT 310 through the A1p and A2p interfaces to the MSCe 340. The ANTS/ANC 330 and 335 correspond to the CDMA 2000 1× EV-DO AN/PCF.

In this case, an RTP payload type between the ANTS/ANC 330 and 335 and the MSCe 340 is set to coincide with an RTP payload type between the ANTS/ANC 330 and 335 and the AT 310. Thereafter, the ANTS/ANC 330 and 335 deliver the RTP packet.

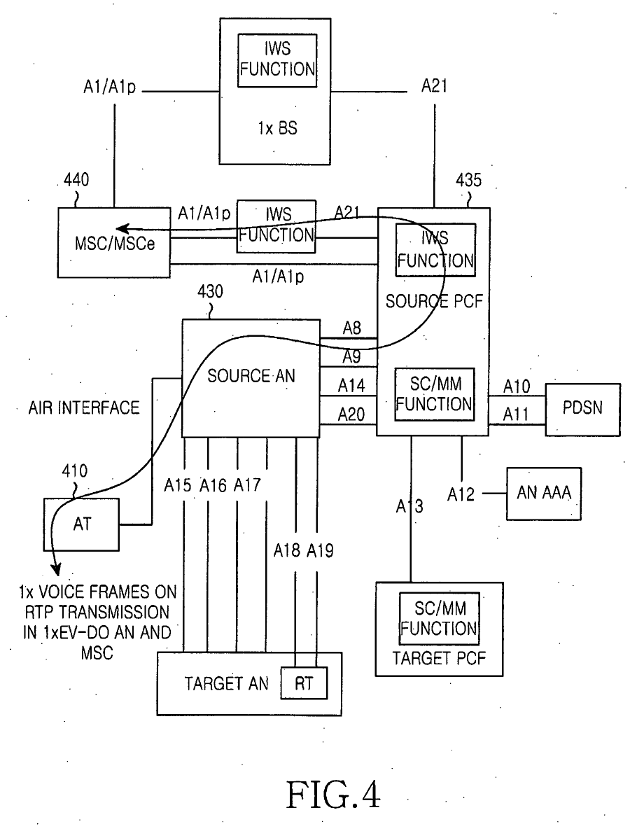

FIG. 4 is a view for illustrating a process of handling RTP transmission traffic including a CDMA 2000 1× voice frame between an MSC and an MS according to an exemplary embodiment of present invention. FIG. 4 comprises an AT 410, a Source AN 430, a Source PCF 435 and an MSC/MSCe 440. Remaining elements are shown for reference but are not described in further detail. A curve indicated by a solid line arrow represents an exemplary path along which an RTP packet is transmitted.

Unlike FIG. 3, the MSC 440 is used instead of an MSCe in the process of FIG. 4. When an RTP packet is transmitted in a direction from the AT 410 to the MSC 440, the RTP packet is converted to Pulse Code Modulation (PCM) data by the use of a converting device such as an InterWorking Solution (IWS).

When the RTP packet is transmitted in the reverse direction, i.e., from the MSC 440 to the AT 410, the PCM data is converted by the IWS and is then transmitted after being included in a payload of an RTP packet.

Now, a technique will be described in which an MS performs a handoff, and a CDMA 2000 1× voice service is provided to a CDMA 2000 1× BS while the CDMA 2000 1× voice service is being provided in a CDMA 2000 1× EV-DO AN/PCF packet session when a session is reestablished as a result of the handoff.

Even after the handoff is performed, if a CDMA 2000 1× EV-DO packet session is maintained, and a CDMA 2000 1× voice service can be continuously provided over RTP, the CDMA 2000 1× voice service can be provided through the CDMA 2000 1× EV-DO packet session as in the conventional method.

In a case where the CDMA 2000 1× EV-DO packet session must be reestablished, an MS transmits/receives an RTP packet to/from a different CDMA 2000 1× EV-DO AN/PCF. Thus, an IP address and a UDP port have to be modified.

Accordingly, if the CDMA 2000 1× EV-DO packet session is reestablished in a state where the CDMA 2000 1× EV-DO packet session is activated and the CDMA 2000 1× voice service is provided using the CDMA 2000 1× EV-DO packet session, then the CDMA 2000 1× EV-DO packet session is changed to a dormant state, and the CDMA 2000 1× voice service performs a handoff operation for a CDMA 2000 1× voice call using a CDMA 2000 1× BS of a cell toward which the MS moves.

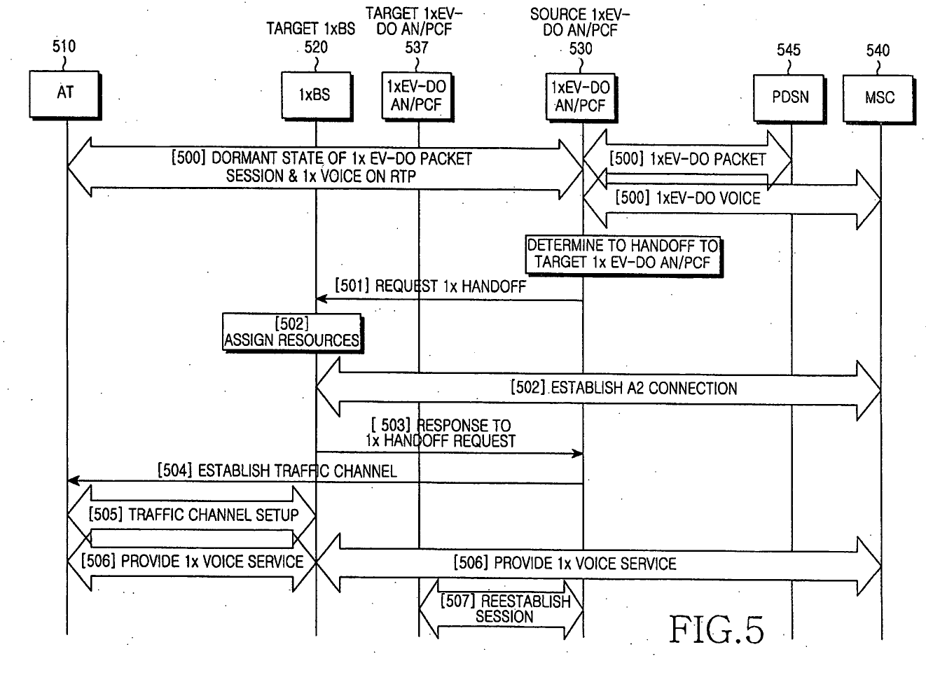

FIG. 5 illustrates a process of a CDMA 2000 1× voice handoff from a CDMA 2000 1× EV-DO AN/PCF to a CDMA 2000 1× BS according to an exemplary embodiment of present invention. FIG. 5 illustrates communications between the AT 510, target 1× BS 520, source 1× EV-DO AN/PCF 530, target 1× EV-DO AN/PCF 537, MSC 540 and PDSN 545.

Referring to FIG. 5, in steps 500, the AT 510 is connected to a CDMA 2000 1× EV-DO packet session, and provides a CDMA 2000 1× voice service using the connected CDMA 2000 1× EV-DO packet session.

In step 501, if the CDMA 2000 1× EV-DO session for the AT 510 is determined to be reestablished to the target 1× EV-DO AN/PCF 537, the source 1× EV-DO AN/PCF 530 requests a CDMA 2000 1× handoff to the target 1× BS 520 whose coverage overlaps that of the target 1× EV-DO AN/PCF 537.

In steps 502, if the target 1× BS 520 successfully assigns a CDMA 2000 1× traffic channel and also completely establishes an A2 interface for the MSC 540, then notification is provided to the source 1× EV-DO AN/PCF 530 in step 503. That is, the target 1× BS 520 responds to the handoff request of step 501.

In step 504, the source 1× EV-DO AN/PCF 530 releases a call for the CDMA 2000 1× EV-DO packet session, and transmits a channel assignment message including traffic channel information provided by the target 1× BS 520 to the AT 510.

In step 505, the AT 510 changes the CDMA 2000 1× EV-DO packet session to a dormant state, and converts a currently used voice channel to a traffic channel provided by the target 1× BS 520 as indicated by the channel assignment message.

In steps 506, for continuous delivery of a voice service, the AT 510 continuously transmits voice data for a voice call to the target 1× BS 520. The voice data is also transmitted/received between the target 1× BS 520 and the MSC 540.

In step 507, the CDMA 2000 1× EV-DO packet session in a dormant state is reestablished from the source 1× EV-DO AN/PCF 530 to the target 1× EV-DO AN/PCF 537.

After step 507, when a user transmission packet is generated in the CDMA 2000 1× EV-DO packet session, a packet service may be resumed by changing to the CDMA 2000 1× packet session, or the packet service may be temporarily stopped until the CDMA 2000 1× voice service is finished.

However, while the CDMA 2000 1× voice service is provided using the CDMA 2000 1× EV-DO packet session, it is preferable that the CDMA 2000 1× voice service is continuously provided using the CDMA 2000 1× EV-DO packet session while avoiding the reestablishment of the CDMA 2000 1× EV-DO packet session.

Now, an apparatus for concurrently supporting a CDMA 2000 1× voice service and a high speed data service through a CDMA 2000 1× EV-DO packet session will be described in accordance with an exemplary embodiment of the present invention.

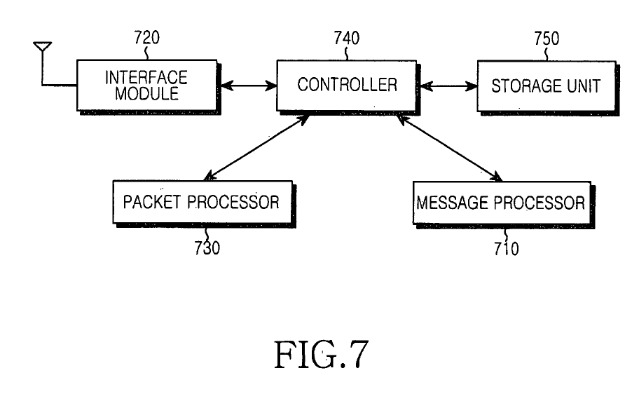

FIG. 7 is a block diagram of a BS that supports a CDMA 2000 1× voice service based on RTP in a state where a CDMA 2000 1× EV-DO session is activated according to an exemplary embodiment of the present invention. The BS may include a typical BS function and a control station function.

Referring to FIG. 7, the BS (or CDMA 2000 1× EV-DO AN/PCF) comprises an interface module 720, a controller 740, a storage unit 750, a packet processor 730, and a message processor 710. The controller 740 preferably provides the overall control of the BS.

Specifically, the controller 740 controls voice calls and data communications. According to an exemplary embodiment of the present invention, in addition to its typical functions, the controller 740 performs a CDMA 2000 1× voice service over RTP in a state where the CDMA 2000 1× EV-DO session is activated.

The controller 740 receives a message from a higher layer network device or an MS, and provides it to the message processor 710. Further, the controller 740 receives a message from the message processor 710, and provides it to the interface module 720, so as to be delivered to the higher layer network device or the MS.

Further, the controller 740 provides a data packet (e.g., RTP packet) to the data packet processor 730 when the data packet is received from the higher layer network device or the MS. Upon receiving a data packet (e.g., RTP packet) to be transmitted from the packet processor 730 to the higher layer network device or the MS, the controller 740 provides the received data packet to the interface module 720.

A CDMA 2000 1× voice service may be provided using the CDMA 2000 1× EV-DO session in a state where the MS is connected to the CDMA 2000 1× EV-DO session. In this case, when the connected CDMA 2000 1× EV-DO session needs to be reestablished, the controller 740 performs a CDMA 2000 1× handoff to a specific CDMA 2000 1× BS whose coverage overlaps that of the BS. In addition, the controller 740 allows the message processor 710 to transmit a handoff request message.

The message processor 710 analyzes the message received from the higher layer network device or the MS, and notifies the controller 740 of the result. Further, the message processor 710 generates a message to be transmitted to the higher layer network device or the MS, and provides it to the interface module 720 under the control of controller 740.

According to exemplary embodiments of the present invention, when the controller 740 performs CDMA 2000 1× paging for the MS in a state where the CDMA 2000 1× EV-DO session is connected, a DBM including information for using RTP is generated. The DBM received from the MS is analyzed, and the analysis result is provided to the controller 740.

The message processor 710 generates a handoff request message by which a CDMA 2000 1× voice service using the connected CDMA 2000 1× EV-DO session is converted to a CDMA 2000 1× voice service provided by the CDMA 2000 1× BS under the control of the controller 740.

The packet processor 730 provides a data packet (e.g., RTP packet) received from the MS to the interface module 720 under the control of the controller 740, so as to transmit the data packet to a higher layer network device.

To be transmitted to the MS, the data packet (e.g., RTP packet) received from the higher layer network device is provided to the interface module 720 via the controller 740.

In this case, information included in the data packet exchanged between the MS and the higher layer network device has to be maintained to coincide with information contained in the message “A2p Bearer Session Level Parameter” exchanged between the CDMA 2000 1× AN/PCF and the MSCe and information contained in the message “A2p Format-specific parameter”.

The storage unit 750 stores a program for controlling overall operations of the BS and temporary data produced during the execution of the program.

The interface module 720 is used to communicate with the higher layer network device or the MS. For communication with the MS, the interface module 720 includes for example, a Radio Frequency (RF) processor and a baseband processor. The RF processor converts a signal received through an antenna to a baseband signal, and provides the baseband signal to the baseband processor. Thereafter, the baseband signal is converted to an RF signal so as to be transmitted over the air, and the RF signal is transmitted through the antenna. For example, when a CDMA scheme is used, data to be transmitted is subject to channel-coding and spreading, and data to be received is subject to de-spreading and channel-decoding. The module for communication with the higher layer network device includes a baseband processor and a wired processor. A physical transmission interface used by the wired processor may employ a variety of techniques including optical communication.

The controller 740 controls the packet processor 730 and the message processor 710.

The controller 740 may also perform functions of one or both of the packet processor 730 and the message processor 710. Although distinctively depicted in FIG. 7, in practice, both or either one of the packet processor 730 and the message processor 710 may be controlled by the controller 740, and/or both or either one of the functions of the packet processor 730 and the message processor 710 can be performed by the controller 740. A sub-processor for each of the packet processor 730 and the message processor 710 may be additionally provided, and a function of the sub-processor may be performed by the controller 740.

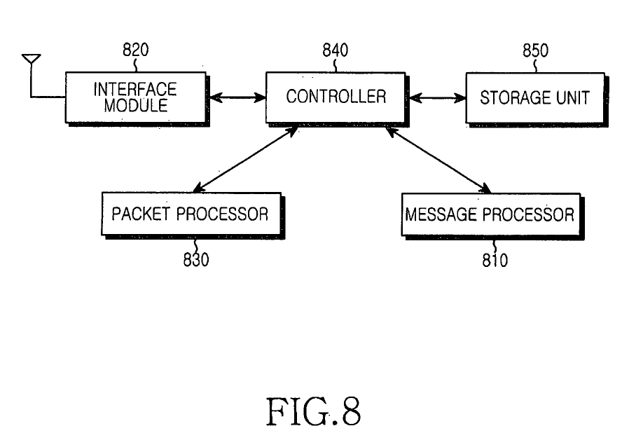

FIG. 8 is a block diagram of an MS that supports a CDMA 2000 1× voice service based on RTP in a state where a CDMA 2000 1× EV-DO session is activated according to an exemplary embodiment of the present invention.

Referring to FIG. 8, the MS comprises an interface module 820, a controller 840, a storage unit 850, a packet processor 830, and a message processor 810. The controller 840 preferably provides the overall control of the MS.

Specifically, the controller 840 controls voice calls and data communications. According to an exemplary embodiment of the present invention, in addition to its typical functions, the controller 840 performs a CDMA 2000 1× voice service over RTP in a state where the CDMA 2000 1× EV-DO session is activated.

The controller 840 receives a message from a higher layer network device and provides it to the message processor 810. Further, the controller 840 receives a message from the message processor 810 and provides it to the interface module 820 so as to be delivered to the higher layer network device.

Further, the controller 840 provides a data packet (e.g., RTP packet) to the data packet processor 830 when the data packet is received from the higher layer network device. Upon receiving a data packet (e.g., RTP packet) to be transmitted from the packet processor 830 to the higher layer network device, the controller 840 provides the received data packet to the interface module 820.

The message processor 810 analyzes the message received from the higher layer network device, and notifies the controller 840 of the result. Further, the message processor 810 generates a message to be transmitted to the higher layer network device, and provides it to the interface module 820 under the control of controller 840.

According to embodiments of the present invention, when the controller 840 receives a CDMA 2000 1× paging request in a state where the CDMA 2000 1× EV-DO session is connected, the DBM including information for using RTP is analyzed, and the analysis result is provided to the controller 840.

In addition, the DBM including the information for using RTP is generated, and is provided to the interface module 820 together with a paging response message under the control of the controller 840.

The packet processor 830 extracts CDMA 2000 1× voice data (e.g., EVRC data) from data packet (e.g., RTP packet) received from the higher layer network device under the control of the controller 840. Then, the CDMA 2000 1× voice data (e.g., EVRC data) included in the data packet is transmitted to the interface module 820 under the control of the controller 840.

The storage unit 850 stores a program for controlling overall operations of the MS and temporary data produced during the execution of the program.

The interface module 820 is used to communicate with the higher layer network device and includes for example, an RF processor and a baseband processor.

The RF processor converts a signal received through an antenna to a baseband signal, and provides the baseband signal to the baseband processor. Thereafter, the baseband signal is converted to an RF signal so as to be transmitted over the air, and the RF signal is transmitted through the antenna.

For example, when a CDMA scheme is used, data to be transmitted is subject to channel-coding and spreading, and data to be received is subject to de-spreading and channel-decoding.

The controller 840 controls the packet processor 830 and the message processor 810. The controller 840 may also perform functions of one or both of the packet processor 830 and the message processor 810. Although distinctively depicted in FIG. 8, in practice, both or either one of the packet processor 830 and the message processor 810 may be controlled by the controller 840, and/or both or either one of the functions of the packet processor 830 and the message processor 810 can be performed by the controller 740.

A sub-processor for each of the packet processor 830 and the message processor 810 may be additionally provided, and a function of the sub-processor may be performed by the controller 840.

According to exemplary embodiments of the present invention, it is possible to provide a CDMA 2000 1× voice service while continuously providing a high speed service in a state where a CDMA 2000 1× EV-DO packet session is connected between an MS and a CDMA 2000 1× EV-DO AN/PCF.

In addition, a CDMA 2000 1× voice incoming call directed to the MS can be provided with a reduced time delay in a state where a CDMA 2000 1× EV-DO packet session is connected between an MS and a CDMA 2000 1× EV-DO AN/PCF.

In addition, since a CDMA 2000 1× voice service can be provided through a CDMA 2000 1× EV-DO network by interworking a CDMA 2000 1× EV-DO network and a CDMA 2000 1× network, evolution to a VoIP network can be effectively achieved.

While the present invention has been shown and described with reference to certain exemplary embodiments thereof, it will be understood by those skilled in the art that various changes in form and detail may be made therein without departing from the spirit and scope of the invention as defined by the appended claims and their equivalents.

What is claimed is:

1. A method of concurrently supporting a data service and a circuit based voice service when a mobile communication system is operating in the data mode, comprising:
when a Base Station (BS) pages a Mobile Station (MS) in the data mode, forming a message to provide the circuit based voice service in the data mode by the BS and transmitting the message to the MS;
forming a message as response to provide the circuit based voice service in the data mode by the MS and transmitting the message to the BS; and
establishing a traffic channel and a Quality of Service (QoS) setup to provide the circuit based voice in the data mode service by using the information included in the messages.

2. The method of claim 1, further comprising:
establishing by the BS, a traffic channel to an MSC Emulation (MSCe) to provide the circuit based voice service in the data mode; and
providing the circuit based voice service in the data mode by exchanging data packets in which voice data is encapsulated, between the MS and the MSCe.

3. The method of claim 1, wherein the message formed by the BS to provide the circuit based voice service in the data mode, contains an Internet Protocol (IP) address of a the BS, a User Datagram Protocol (UDP) port to be used, a Real-time Transfer Protocol (RTP) payload type, and the number of voice frames included in one RTP packet.

4. The method of claim 1, wherein information in the message formed by the BS to provide the circuit based voice service in the data mode, is maintained to coincide with information included in a message “A2p Bearer Session Level Parameter” exchanged between the BS and the MSCe and information included in a message “A2p Format-specific parameter”.

5. The method of claim 1, wherein the message formed by the BS to provide the circuit based voice service in the data mode is a Data Burst Message (DBM).

6. The method of claim 1, wherein the message formed by the MS to provide the circuit based voice service in the data mode, contains an IP address of the MS, a UDP port to be used, a RTP payload type, and the number of voice frames included in one RTP packet.

7. The method of claim 1, wherein information in the message formed by the MS to provide the circuit based voice service in the data mode, is maintained to coincide with information included in a message “A2p Bearer Session Level Parameter” exchanged between the BS and the MSCe and information included in a message “A2p Format-specific parameter”.

8. The method of claim 1, wherein the message formed by the MS to provide the circuit based voice service in the data mode, is a DBM.

9. The method of claim 2, wherein, instead of the MSCe, a Mobile Switching Center (MSC) is used data format conversion is performed in an InterWorking Solution (IWS).

10. A handoff method of a mobile communication system when a data session is changed in a state a circuit based voice service in the data mode is provided in the data mode, comprising:
determining a handoff by a Base Station (BS) operating in the data mode, and requesting a BS operating in a circuit mode to perform a handoff for the voice service in the circuit mode;
releasing a circuit based voice service in the data mode by the BS operating in the data mode,
providing channel allocation information on the circuit mode to a Mobile Station (MS) by the BS operating in the data mode;
changing the circuit based voice service from the data mode to the circuit mode by the MS, and
transferring the data session by the BS operating in the data mode to a target BS whose coverage overlaps that of the BS operating in the circuit mode.

11. The handoff method of claim 10, wherein the handoff is determined in a state where the data session is updated so that the circuit based voice service in the data mode is no longer continuously provided in the data mode as the MS moves.

12. A Base Station (BS) apparatus for concurrently supporting a data service and a circuit based voice service when a mobile communication system is operating in the data mode, comprising:
a data packet processor for receiving a data packet from an upper network device or a Mobile Station (MS) and respectively transmit it to the MS or the upper network device through an interface module, managing data consistency between the data and control information for delivery of the data packet;
a message processor for controlling a flow of the data packet, generating a message to be transmitted to the MS wherein the message includes information to provide a circuit based voice service in the data mode, and analyzing a response message transmitted from the MS to obtain the information; and
a controller for controlling the data packet processor and the message processor and supporting both the data service and the circuit based voice service, in the data mode and if a session has to be changed in the data mode, determining a voice handoff to a BS in the circuit mode whose coverage overlaps that of the BS.

13. The apparatus of claim 12, wherein, the controller determines the handoff in a state where a data session is updated so that the circuit based voice service in the data mode is no longer continuously provided in the data mode as the MS moves.

14. The apparatus of claim 12, wherein a message is generated to include information to provide the circuit based voice service in the data mode, and wherein the message is transmitted together with a circuit-mode paging request message.

15. The apparatus of claim 12, wherein the message to provide the circuit based voice service in the data mode and which is transmitted to the MS, contains an Internet Protocol (IP) address of the BS, a User Datagram Protocol (UDP) port to be used, a Real-time Transfer Protocol (RTP) payload type, and the number of voice frames included in one RTP packet.

16. The apparatus of claim 12, wherein the message to provide the circuit based voice service in the data mode and which is transmitted to the MS, is a Data Burst Message (DBM).

17. The apparatus of claim 12, wherein the response message is generated by the MS and is transmitted together with a circuit-mode paging request response message.

18. The apparatus of claim 12, wherein the response message contains an IP address of the MS, a UDP port to be used, a RTP payload type, and the number of voice frames included in one RTP packet.

19. The apparatus of claim 12, wherein the response message is a DBM.

20. The apparatus of claim 12, wherein the data packet processor controls an IP address, a UDP port, and a payload type of a data packet to maintain data consistency between the data and control information for delivery of the data packet;

21. The apparatus of claim 12, wherein the data packet processor manages the data consistency by coinciding with information included in a message “A2p Bearer Session Level Parameter” and information included in a message “A2p Format-specific parameter”.

22. A Mobile Station (MS) apparatus for concurrently supporting a data service and a circuit based voice service when a mobile communication system is operating in the data mode, comprising:
a data packet processor for receiving a data packet from a Base Station (BS) and obtaining voice data from the data packet and encapsulating the voice data into data packet for transmitting to the BS;
a message processor for controlling a flow of the data packet, using a message transmitted from the BS to obtain information to provide the circuit based voice service in the data mode and generating a response message including the information; and
a controller for controlling the data packet processor and the message processor.

23. The apparatus of claim 22, wherein the message transmitted from the BS is transmitted together with a circuit-mode paging request message.

24. The apparatus of claim 22, wherein the message transmitted from the BS contains an Internet Protocol (IP) address of the BS, a User Datagram Protocol (UDP) port to be used, a Real-time Transfer Protocol (RTP) payload type, and the number of voice frames included in one RTP packet.

25. The apparatus of claim 22, wherein the message transmitted from the BS is a Data Burst Message (DBM).

26. The apparatus of claim 22, wherein the response message is transmitted together with a circuit-mode paging request response message.

27. The apparatus of claim 22, wherein the response message contains an IP address of the MS, a UDP port to be used, a RTP payload type, and the number of voice frames included in one RTP packet.

28. The apparatus of claim 22, wherein the response message is a DBM.

29. A mobile communication system for concurrently supporting a data service and a circuit based voice service when the mobile communication system is operating in the data mode, comprising:
a Base Station (BS) for, while a data service is provided to a Mobile Station (MS), transmitting a paging request message and a message to provide the circuit based voice service in the data mode and providing the circuit based voice service in the data mode when a response message is received; and
the MS for receiving the paging request message and the message to provide the circuit based voice service in the data mode, transmitting the response message, and receiving the circuit based voice data included in the data packet and encapsulating the voice data into a data packet for transmitting to the BS;

30. The mobile communication system of claim 29, wherein, the BS determines the handoff in a state where a data session is updated so that the circuit based voice service in the data mode is no longer continuously provided in the data mode as the MS moves.

31. The mobile communication system of claim 29, wherein the message to provide the circuit based voice service in the data mode, contains an Internet Protocol (IP) address of the BS, a User Datagram Protocol (UDP) port to be used, a Real-time Transfer Protocol (RTP) payload type, and the number of voice frames included in one RTP packet.

32. The mobile communication system of claim 29, wherein the message to provide the circuit based voice service in the data mode, is a Data Burst Message (DBM).

33. The mobile communication system of claim 29, wherein the response message contains an IP address of the MS, a UDP port to be used, a RTP payload type, and the number of voice frames included in one RTP packet.

34. The mobile communication system of claim 29, wherein the response message is a DBM.

35. The mobile communication system of claim 29, wherein the BS is configured to allow information included in a message “A2p Bearer Session Level Parameter” and information included in a message “A2p Format-specific parameter” to coincide with information containing an IP address of a device that transmits the information, a UDP port to be used, a RTP payload type, and the number of voice frames included in one RTP packet.

36. A method of a Base Station (BS) concurrently supporting a data service and circuit based voice service in the data mode, comprising the steps of:
when pages a Mobile Station (MS) in the data mode, forming a message to provide the circuit based voice service in the data mode and transmitting the message to the MS;
receiving a response message from the MS wherein the response message to provide the circuit based voice service in the data mode;
establishing a traffic channel and a Quality of Service (QoS) setup to provide the circuit based voice service in the data mode by using information included in the response message;
establishing a traffic channel to an MSC Emulation (MSCe) to provide the circuit based voice service in the data mode; and
encapsulating voice data into data packet between the MS and the MSCe.

37. The method of claim 36, wherein the message to provide the circuit based voice service in the data mode contains an Internet Protocol (IP) address of the BS a User Datagram Protocol (UDP) port to be used, a Real-time Transfer Protocol (RTP) payload type, and the number of voice frames included in one RTP packet.

38. The method of claim 36, wherein to provide the circuit based voice service in the data mode is maintained to coincide with information included in a message “A2p Bearer Session Level Parameter” and information included in a message “A2p Format-specific parameter”.

39. The method of claim 36, wherein the response message contains an IP address of the MS, a UDP port to be used, a RTP payload type, and the number of voice frames included in one RTP packet.

40. The method of claim 36, wherein the information to provide the circuit based voice service in the data mode is maintained to coincide with information included in a message “A2p Bearer Session Level Parameter” and information included in a message “A2p Format-specific parameter”.

41. The method of claim 36, wherein, instead of the MSCe, a Mobile Switching Center (MSC) is used data format conversion is performed in an InterWorking Solution (IWS).

42. The method of claim 36, wherein the message and the response message are Data Burst Messages (DBMs).

43. A method of a Mobile Station (MS) in a mobile communication system for concurrently supporting a data service and circuit based voice service in the data mode, comprising the steps of:
receiving a message from a Base Station (BS) wherein the message includes to provide the circuit based voice service in the data mode;
transmitting a response message to the BS wherein the response message to provide the circuit based voice service in the data mode;
establishing a traffic channel and a Quality of Service (QoS) setup with the BS to provide the circuit based voice in the data mode by using information in the message; and
providing the circuit based voice service in the data mode.

44. The method of claim 43, wherein the message to provide the circuit based voice service in the data mode is transmitted together with a circuit-mode paging request message from the BS operating in the data mode.

45. The method of claim 43, wherein the message to provide the circuit based voice service in the data mode contains an Internet Protocol (IP) address of the BS, a User Datagram Protocol (UDP) port to be used, a Real-time Transfer Protocol (RTP) payload type, and the number of voice frames included in one RTP packet.

46. The method of claim 43, wherein the response message is transmitted together with a circuit-mode paging request response message.

47. The method of claim 43, wherein the response message contains an IP address of the MS, a UDP port to be used, a RTP payload type, and the number of voice frames included in one RTP packet.

48. The method of claim 43, wherein the message and the response message are Data Burst Messages (DBMs).
